(19) United States
(12) Patent Application Publication
(10) Pub. No.: US 2024/0313334 A1
(43) Pub. Date: Sep. 19, 2024

(54) EMERGENCY DEGASSING ARRANGEMENT, MOTOR VEHICLE, AND METHOD FOR DISCHARGING GAS EMERGING FROM A BATTERY CELL FROM A MOTOR VEHICLE

(71) Applicant: AUDI AG, Ingolstadt (DE)

(72) Inventors: Imke DITTMANN, Ingolstadt (DE); Thomas MILDE, Wüstenrot (DE)

(73) Assignee: AUDI AG, Ingolstadt (DE)

(21) Appl. No.: 18/443,566

(22) Filed: Feb. 16, 2024

(30) Foreign Application Priority Data
Mar. 15, 2023 (DE) 102023106417.7

(51) Int. Cl. H01M 50/325; B60R 16/04

(52) U.S. Cl. CPC H01M 50/325; B60R 16/04; H01M 2220/20

(57) ABSTRACT

An emergency degassing arrangement for a motor vehicle, which has a gas discharge channel for discharging gases emerging from a battery cell from the motor vehicle into the surroundings of the motor vehicle, an outlet opening of the gas discharge channel located at one end of the gas discharge channel and opening into the surroundings, and an emergency degassing device which is arranged at the end of the gas discharge channel and has a closure. This closure comprises a flap which is rotatably mounted around a pivot axis for closing the outlet opening, and the flap is transferable from a closed position to at least one open position by rotating around the pivot axis, in which a gas flowing out of the outlet opening and partially flowing against the flap can be diverted by the flap.

### FIELD

The invention relates to an emergency degassing arrangement for a motor vehicle, which has a gas discharge channel for discharging gases emerging from a battery cell from the motor vehicle into the surroundings of the motor vehicle, an outlet opening of the gas discharge channel located at one end of the gas discharge channel and opening into the surroundings, and an emergency degassing device, which is arranged at the end of the gas discharge channel and has a closure which is designed to close the outlet opening and to release the outlet opening in order to discharge the gases into the surroundings. Furthermore, the invention also relates to a motor vehicle having such an emergency degassing arrangement and a method for discharging a gas emerging from a battery cell from a motor vehicle.

### BACKGROUND

For the controlled removal of harmful gases in case of a thermal runaway of one or more battery cells within a battery, for example a high-voltage battery of a motor vehicle, components such as valves or bursting elements are installed on the batteries. Various opening mechanisms can be used.

For example, DE 10 2019 118 182 A1 describes an emergency degassing valve for a battery housing of a high-voltage battery for releasing a hot gas from the interior of the battery housing. The emergency degassing valve comprises a valve seat to be fastened to the battery housing and a valve body for closing the flow channel that extends through the valve seat. The emergency degassing valve is designed as a spring-loaded full-stroke safety valve and has a spring clamping unit arranged on the valve seat for this purpose. The valve body is permanently removable from the valve seat to provide an open state of the emergency degassing valve while releasing the entire flow channel. In addition, an opening of the valve seat facing toward the surroundings can be covered by a cover element, for example a protective film, wherein the valve body penetrates the cover element or detaches it from the opening when leaving the flow channel.

DE 10 2020 005 166 A1 describes a battery having at least one cell module comprising multiple individual cells and a housing surrounding the cell module, and having an outflow channel for gases for the case of thermal damage to one of the individual cells, wherein the outflow channel is formed in the interior of the housing and is connected to the rest of the interior of the housing via a filter element. Furthermore, the outflow channel is connected to the exterior of the housing via at least one emergency degassing element and the filter element is formed by a plurality of openings in a channel wall of the outflow channel. The emergency degassing element can comprise a bursting element.

If such a harmful gas is conducted out of the motor vehicle, this should be done in a way that is as harmless as possible for people, for example vehicle occupants, who are currently leaving the vehicle.

### SUMMARY

The object of the present invention is therefore to provide an emergency degassing arrangement, a motor vehicle, and a method which make it possible to discharge gas escaping from a battery cell into the surroundings of the motor vehicle and at the same time ensure the highest possible level of safety for people in the vicinity of the motor vehicle.

An emergency degassing arrangement for a motor vehicle according to the invention has a gas discharge channel for discharging gases emerging from a battery cell from the motor vehicle into the surroundings of the motor vehicle, an outlet opening of the gas discharge channel located at one end of the gas discharge channel and opening into the surroundings, and an emergency degassing device, which is arranged at the end of the gas discharge channel and has a closure which is designed to close the outlet opening and to release the outlet opening in order to discharge the gases into the surroundings. The closure has a flap which is rotatably mounted around a pivot axis for closing the outlet opening, wherein the flap is transferable from a closed position to at least one open position by rotating around the pivot axis, in which a gas flowing out of the outlet opening and partially flowing against the flap can be diverted by the flap.

The invention is based on the knowledge that conventional emergency degassing elements and emergency degassing valves are generally designed in such a way that they primarily represent a scattering and uncontrolled distribution of the emerging gas in all spatial directions. In principle, this poses an additional potential hazard for people who are in such a situation near the motor vehicle and, for example, near such an outlet. By designing the emergency degassing device having a flap pivotable around a pivot axis, which can be used at the same time for the directed deflection or guidance of the emerging gas flow when the gas emerges, it is advantageously possible to integrate such a gas guiding function for the directed gas exhaust in the emergency degassing device with the aid of a special opening design of the valve, namely the flap pivotable around the pivot axis. A directed harmful gas discharge is now advantageously possible, which can increase the level of safety of vehicle occupants, especially when leaving the vehicle in case of a thermal event. The gas can be directed deliberately to areas on the vehicle where the potential hazard for such occupants or people in the vicinity of the motor vehicle is low. For example, by pivoting the flap up during the gas exhaust, the gas can be directed diagonally downwards towards the ground or underlying surface via the partially pivoted-up flap. This can minimize the potential hazard to people in the vicinity. By designing it as a flap, it can also be achieved that when the gas flow is redirected, it is only deflected slightly. In comparison to existing concepts, the gas is swirled significantly less. The gas exhaust is therefore much more controlled. The invention thus advantageously provides the possibility of directional gas guidance along the opening flap in case of triggering.

The gas discharge channel can be defined as a free area through which flow can occur and which is delimited or surrounded, for example, by a channel wall. Such a gas discharge channel can be integrated into a battery housing or can also be arranged outside of such a battery housing or can also be partially led within a battery housing and partially extend outside of such a battery housing. Such a gas discharge channel can also be coupled or become coupled to a vehicle battery or the battery cells comprised by it in such a way that gas emerging from such a battery cell is introducible into the gas discharge channel. By way of such a gas discharge channel it is therefore possible to discharge the gas emerging from a battery cell in case of a thermal runaway of such a battery cell from the vehicle battery and in particular from the vehicle and into the surroundings of the vehicle. The end of the gas discharge channel is defined here as the interface between the gas discharge channel and the surroundings of the motor vehicle. The end of the gas discharge channel having the outlet opening therefore represents the orifice area into the surroundings. Gas which leaves the outlet opening at this end of the gas discharge channel is accordingly fed to the surroundings of the motor vehicle. In principle, a single such gas discharge channel can be provided for a motor vehicle battery or multiple gas discharge channels can also be provided. In addition, the gas discharge channel can also be part of a channel system, in particular a branching channel system. In principle, such a channel system can also provide not only one orifice point into the surroundings, but can also comprise, for example, multiple such orifice points and accordingly multiple corresponding outlet openings. In principle, a corresponding emergency degassing device can also be provided at each such outlet opening. The features described for the present emergency degassing device and the embodiments described further below can then apply analogously to such optional further emergency degassing devices that are provided at further optional outlet openings.

To rotatably mount the flap on the pivot axis, the emergency degassing device can, for example, comprise a hinge and/or a pivot joint or the like. If no gas emerges from the outlet opening, the flap is in the closed position. In case of gas emerging from a battery cell, the flap can be transferred into the at least one open position, due to which the gas can emerge from the outlet opening or the exhaust opening. The flap can be opened purely passively, namely caused by the gas pressure of the gas emerging from the battery cell, which flows through the gas discharge channel and strikes the closed flap accordingly. The flap is preferably designed so that it opens in a pressure-controlled and passive manner. There is therefore no need for active control of the flap in order to open it and thereby release the outlet opening.

The outlet opening is in particular completely closable by the flap. The outlet opening is then covered by the flap described as the single flap.

In addition, the flap can have multiple open positions, which differ, for example, in the opening angle in relation to the flap in the closed position. In other words, the flap can be pivoted open to a greater or lesser extent to release the outlet opening. Optionally, a stop can also be provided which defines a maximum opening angle for the flap in the open position and thus limits a maximum opening of the flap.

In principle, the flap and in general the emergency degassing device can be made of any material, for example a metallic material, a plastic, or a fiber-reinforced plastic. The gas discharge channel can, for example, also be designed in such a way that the gas emerging from the battery cell and introduced into the gas discharge channel is first deflected and/or swirled and/or passes through a filter element or the like. This allows the gas to be slowed down, particles entrained in the gas flow to be separated, and the gas as a whole to be cooled before it ultimately emerges from the outlet opening. Therefore, a plastic can generally also be used as the material for the flap or for the emergency degassing device, since the flap then does not have to withstand particularly high temperatures.

In a further advantageous embodiment of the invention, the emergency degassing device has a restoring device which is designed to exert a restoring force on the flap from the at least one open position in the direction of the closed position. This restoring force counteracts the gas flow flowing out of the outlet opening via the flap. This allows this gas flow to be deflected and guided in a much more controlled and situation-adapted manner. Such a restoring force can also be used efficiently to prevent the flap from opening too far and then no longer being able to perform its guiding function, and in particular also without the need for an above-mentioned stop to limit the maximum opening angle. Above all, however, the advantage of providing a restoring device is that this allows the flap to be opened depending on the gas flow, as will be explained in more detail later. The stronger the gas flow, the further the flap can correspondingly open. This prevents the flap from obstructing the gas exhaust without losing its deflection effect.

In a further advantageous embodiment of the invention, the restoring device is designed such that the flap is held in the closed position by the restoring device in the absence of a counterforce that counteracts the restoring force. This can advantageously ensure reliable closing of the outlet opening when not in use, i.e., when no gas escapes from a battery cell and accordingly no gas has to be discharged from the gas discharge channel. In a normal operating situation, that is, without gas escaping from a battery cell due to thermal runaway of such a battery cell, the flap can ensure reliable closure of the outlet opening and thus reliable protection of the gas discharge channel against the penetration of dirt, contaminants, liquids, or other environmental influences.

According to a further advantageous embodiment of the invention, the restoring device is designed such that an opening angle of the flap in the open position is dependent on the strength of a gas flow flowing out of the outlet opening, wherein the opening angle represents a pivot angle by which the flap is pivoted from the closed position the open position around the pivot axis. A small opening angle therefore means that the opening released by the flap is relatively small, and a large opening angle correspondingly means that the opening released by the flap is larger. How far the flap is pivoted open when the outlet opening is released can be controlled accordingly by the strength of the outflowing gas flow. In particular, the gas pressure acting on the flap causes the flap to open correspondingly wide. If a large amount of gas emerges or a very strong gas flow emerges from the outlet opening, the flap will be pivoted open significantly farther than by a weak gas flow. The flap can therefore advantageously provide a deflection effect, both for weak and strong gas flows, and at the same time the size of the released opening is optimally adapted to the gas flow strength.

There are many different options for designing the restoring mechanism of the restoring device. In the simplest case, the restoring device can comprise at least one restoring spring. On the one hand, this can engage on the flap and, on the other hand, on a component that is stationary with respect to the pivot axis, for example a part of the gas discharge channel. Such a restoring spring can also be provided between two joint elements of the swivel joint, via which the flap is rotatably mounted on the pivot axis.

However, such a restoring mechanism of the restoring device can also be implemented in any other way, for example via a magnetic restoring mechanism and/or an electromagnetic restoring mechanism or the like.

In a further advantageous embodiment of the invention, the pivot axis is arranged laterally to the pivot opening. In other words, the pivot axis is not to extend over the outlet opening. The gas flow flowing out of the outlet opening therefore does not flow against the pivot axis. Preferably, the pivot axis is arranged above the outlet opening and horizontally in relation to an intended installation position in a motor vehicle, in particular if such a motor vehicle is intended to be on a horizontally aligned underlying surface. According to such a preferred installation position, it can be provided in a particularly simple manner that the gas is directed or deflected by the flap obliquely downwards onto the underlying surface on which the motor vehicle is located. In the closed position, the flap completely covers the outlet opening.

In a further advantageous embodiment of the invention, the emergency degassing arrangement has a contact flange on which the outlet opening is circumferentially arranged, wherein the flap rests tightly on the contact flange in the closed position and thus closes the outlet opening to form a seal. This can reliably ensure that in the absence of a gas exhaust from the outlet opening, dirt or contaminants can enter the outlet opening.

In order to achieve such a sealing effect, it is furthermore preferred that the flap has an inside facing toward the outlet opening, which has a sealing element which, in the closed position of the flap, rests circumferentially on the contact flange. For example, if the contact flange is annular, the sealing element can be designed as an annular seal, in particular an annular axial seal, which comes into contact on this annular contact flange when the flap is in the closed position. In principle, however, any other geometry is also conceivable. The contact flange can also be rectangular or triangular in shape, for example. Accordingly, a geometrically adapted sealing element can be provided. The inside of the flap can also be formed over the entire surface having a seal, for example a sealing coating that is elastic. The sealing effect is advantageously further reinforced precisely by the restoring device described above, since the restoring device exerts a restoring force on the flap even in the closed state of the flap, which presses it in the direction of this contact flange.

In a further advantageous embodiment of the invention, the emergency degassing arrangement comprises a battery which has at least one battery cell which has an releasable cell degassing opening, wherein the emergency degassing arrangement is designed such that a gas emerging from the releasable cell degassing opening is introducible into the gas discharge channel.

The battery can have not only a single battery cell, but also, for example, multiple battery cells, in particular numerous battery cells. These can optionally be combined into battery modules. Correspondingly, the battery can comprise multiple battery modules, each of which in turn has multiple battery cells. The battery can be designed, for example, as a high-voltage battery for a motor vehicle. As already mentioned above, not only one gas discharge channel can be provided, but also, depending on the design, multiple gas discharge channels or a channel system which comprises the gas discharge channel described. For example, each battery module can be assigned its own gas discharge channel, so that in case gas emerges from a specific battery cell of such a battery module, the gas emerging from this cell degassing opening of this battery cell is introducible into the assigned gas discharge channel. The gas discharge channels can also be fluidically connected to one another. In other words, the gas introduced into one of the multiple gas discharge channels can also reach another of the gas discharge channels via such a fluidic connection. If there are multiple orifice points into the surroundings, it is preferred that a corresponding emergency degassing device is arranged at a respective end of such a gas discharge channel. If there are multiple gas discharge channels, they can also be combined to form a common orifice point. In this case, only a single outlet opening and accordingly an emergency degassing device arranged thereon would be provided.

In a further advantageous embodiment of the invention, the battery has a battery housing in which the at least one battery cell is arranged. This can be a complete battery housing in which the above-mentioned multiple battery modules can be arranged, each having multiple battery cells. Furthermore, it is advantageous if the gas discharge channel extends at least partially outside the battery housing and the end of the gas discharge channel is arranged outside the battery housing. In this case, a gas emerging from a battery cell can, for example, be led through the battery housing and introduced into the gas discharge channel. The gas discharge channel can, for example, be provided as a space below a high-voltage battery with respect to the preferred installation position in a motor vehicle. For example, the battery can be located in an underbody area of the motor vehicle, and the gas discharge channel can be formed between a housing base of the battery housing and an underrun protection of the motor vehicle. This gap can advantageously be used for the gas discharge, that is to say as the at least one gas discharge channel. In particular, multiple mutually fluidically coupled gas discharge channels can be coupled into this gap. For example, predetermined breaking points can be provided in the housing base, which can be penetrated by the gas emerging from a battery cell in order to reach the gas discharge channel.

Furthermore, it is advantageous if the gas to be discharged is guided via the gas discharge channel into a rear area or a back area of the motor vehicle or alternatively into a front area. The outlet opening is preferably not provided in a side rocker area or in a driver area or front passenger area of the motor vehicle. This advantageously means that there is no risk that vehicle occupants getting out of the vehicle can get into the gas flow that is currently emerging from the outlet opening.

Alternatively, it is also possible for the outlet opening of the gas discharge channel to be designed as an opening in the battery housing. In this case, the gas discharge channel can also be integrated into the interior of the battery housing. In principle, the outlet opening can in turn be integrated into any side wall of such a battery housing, for example, with respect to the preferred installation position in a motor vehicle, in a side wall that faces toward the front of the vehicle or that faces toward the rear of the vehicle or in a housing base of the battery housing, which thus faces toward the underlying surface of the vehicle. Less preferred here is also the positioning on a side wall of the battery housing, which faces toward the side rocker panel areas of the motor vehicle or the driver side or front passenger side.

Furthermore, the invention also relates to a motor vehicle having an emergency degassing arrangement according to the invention or one of its embodiments. The advantages mentioned for the emergency degassing arrangement according to the invention and its designs thus apply similarly to the motor vehicle according to the invention.

The motor vehicle according to the invention is preferably designed as an automobile, in particular as a passenger car or truck, or as a passenger bus or motorcycle.

The invention furthermore also relates to a method for discharging gases emerging from a battery cell from a motor vehicle into the surroundings of the motor vehicle via a gas discharge channel and an outlet opening of the gas discharge channel located at one end of the gas discharge channel and opening into the surroundings, wherein an emergency degassing device is arranged at the end of the gas discharge channel and has a closure which closes the outlet opening when no gas emerges and exposes the outlet opening in order to discharge the gases into the surroundings. The closure has a flap which is rotatably mounted around a pivot axis for closing the outlet opening, and in case of a gas exhaust the flap is transferred from a closed position to at least one open position by rotating around the pivot axis, in which a gas flowing out of the outlet opening and partially flowing against the flap is diverted by the flap.

The advantages mentioned for the emergency degassing device according to the invention and its embodiments thus also apply similarly to the method according to the invention.

The invention also includes refinements of the method according to the invention, which have features as have already been described in conjunction with the refinements of the emergency degassing arrangement according to the invention. For this reason, the corresponding refinements of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic representation of a motor vehicle having an emergency degassing arrangement according to an exemplary embodiment of the invention;

FIG. 2 shows a schematic cross-sectional representation of an emergency degassing arrangement having a flap in a closed position according to an exemplary embodiment of the invention; and

FIG. 3 shows a schematic representation of the emergency degassing arrangement from FIG. 2 having the flap in an open position according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

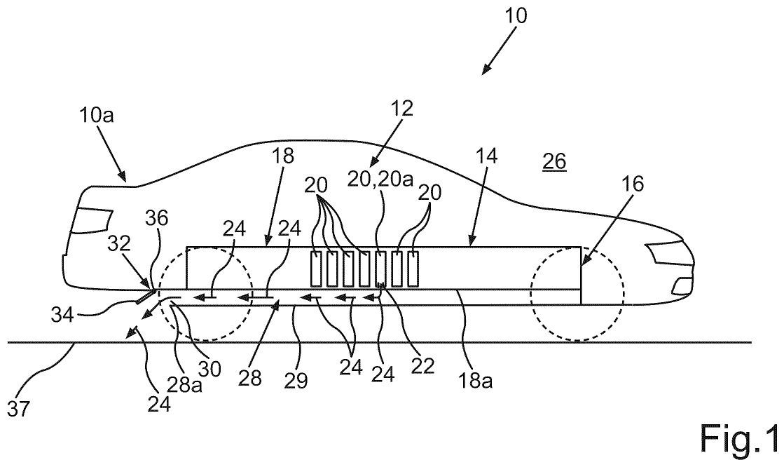

FIG. 1 shows a schematic representation of a motor vehicle 10 having a emergency degassing arrangement 12 according to an exemplary embodiment of the invention. The motor vehicle 10 or the emergency degassing arrangement 12 comprises, on the one hand, a battery 14, which in this example is designed as a high-voltage battery 14. This is arranged in an underbody area 16 of the motor vehicle 10. The battery 14 also comprises a battery housing 18 in which multiple battery cells 20 are arranged. The battery cells 20 can be formed as lithium-ion cells, for example. Each of these battery cells 20 has an releasable cell degassing opening 22, which is only illustrated for one battery cell 20a for reasons of clarity. If a thermal runaway occurs in such a battery cell 20, as illustrated in this example using the battery cell 20a, the gases 24 that arise in the affected battery cell 20a can be discharged in a controlled manner from this releasable cell degassing opening 22. In order to safely discharge the gases 24 emerging from the battery cell 20a from the motor vehicle 10 into the surroundings 26 of the motor vehicle 10, a gas discharge channel 28 is also provided.

In this example, this gas discharge channel 28 is located in an area between a housing base 18a of the battery housing 18 and an underrun protection 29 of the motor vehicle. The housing base 18a of the battery housing 18 can be provided with corresponding predetermined breaking points in order to enable gas 24 emerging from the cell 20a to pass into the gas discharge channel 28.

It is not absolutely necessary for this gas discharge channel 28 to extend outside the battery housing 18. In an alternative embodiment, this can also be partially or completely integrated into the battery housing 18.

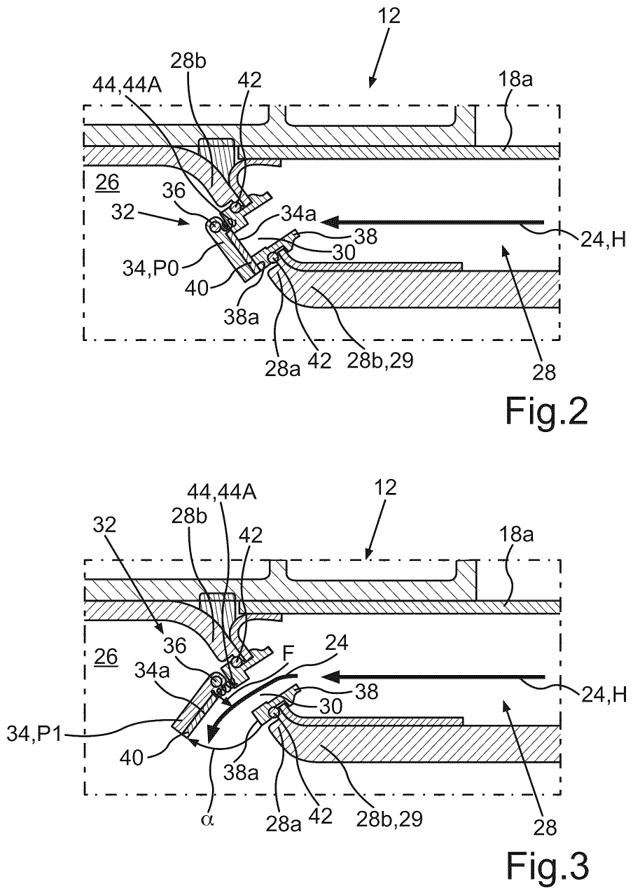

In any case, the gas discharge channel 28 comprises an end 28a having an outlet opening 30. At this end 28a, which in the present example is arranged in the rear area 10a of the motor vehicle 10, in particular in the area of a rear axle of the motor vehicle 10, an emergency degassing device 32 is arranged. This comprises a flap 34, which is rotatably mounted around a pivot axis 36 and is also designed to close the outlet opening 30 in the event that no gas emerges from a cell 20a. If gas emerges, as in the present example, the flap 34 can be opened by the gas pressure of the gas 24 arising in the gas discharge channel 28, in particular purely passively and without any control, in that the flap 34 is pivoted around the pivot axis 36 by the outflowing gas 24. By partially folding up the flap 34, a guiding effect can be exerted on the outflowing gas 24 at the same time. The flap 34 can therefore also be used to guide the gas of the outflowing gas flow 24. In the present example, the outflowing gas flow 24 is deliberately directed obliquely downwards by the flap 34 as the gas emerges from the outlet opening 30 in the direction of the ground or underlying surface 37 on which the motor vehicle 10 is currently located. The emergency degassing arrangement 12 and in particular the emergency degassing device 32 will now be described in more detail with reference to FIG. 2 and FIG. 3.

FIG. 2 shows once again a schematic representation of the emergency degassing arrangement 12 with the emergency degassing device 32 having the flap 34 in the closed position P0 and FIG. 3 shows it in an open position P1. In the closed position P0, as shown in FIG. 2, the flap 34 completely closes the outlet opening 30 and in particular seals it. In this example, the emergency degassing device 32 also has a connector 38 which is arranged at the end 28a of the gas discharge channel 28, in particular on a component providing the channel wall 28b. The connector 38 defines and surrounds the outlet opening 30 and also provides a flap-side contact flange 38a, on which the flap 34 rests with its inside 34a to form a seal when the flap 34 is in the closed position P0. For this purpose, the inside 34a of the flap 34 can also be formed having a seal 40, which rests on the contact flange 38a of the connector 38 to form a seal in the closed position P0 of the flap 34. Alternatively or additionally, the flap-side end face of the contact flange 38a can also be designed having such a seal. In addition, the connector 38 itself can be arranged in a sealed manner on said component 28b via a corresponding seal, for example a ring seal or an O-ring 42.

If no gas is currently emerging, the gas discharge channel 28 is tightly sealed in the area of its end 28a and the outlet opening 30. This means that the channel 28 is particularly well protected against the penetration of dirt or contaminants or the like.

In addition, the emergency degassing device 32 preferably comprises a restoring device 44, which in this example is illustrated as a schematic restoring spring 44A by way of example. The restoring device 44 can also be designed differently and arranged at a different point of the emergency degassing device 32. The restoring device 44 is in particular designed so that it exerts a restoring force F (cf. FIG. 3) on the flap 34, in particular both in the open position P1 (cf. FIG. 3) of the flap 34 and in the closed position P0 as shown in FIG. 2, wherein the restoring force F is not explicitly illustrated in FIG. 2 for reasons of clarity.

The emergency degassing device 32 is furthermore preferably arranged at the end 28a of the gas discharge channel 28 in such a way that a gas flow 24 flowing along the gas discharge channel 28 strikes the flap 34 in the closed position P0. In the closed position P0 of the flap 34, the inside 34a of the flap 34 is preferably not directed parallel to a main flow direction H of the gas flow 24, which is predetermined by the geometry of the gas discharge channel 28, but at an angle thereto. This makes it easier to open the flap when the gas flow 24 strikes it.

FIG. 3 shows a schematic representation of the emergency degassing arrangement 12 from FIG. 2 having the flap 34 in the open position P1. The open position P1 can be assigned an opening angle α, which represents the angle α by which the flap 34 is pivoted around the pivot axis 36 relative to its closed position P0. The opening angle α can vary depending on the strength of the outflowing gas flow 24. The stronger the outflowing gas flow 24, the greater is the opening angle α by which the flap 34 is opened. The restoring device 44 can be designed such that the restoring force F increases as the opening angle α increases. The emergency degassing device 32 can be designed in such a way that a maximum permissible opening angle is also specified, for example by a stop or a suitable design of the restoring device 44. The gas flow 24 striking the flap 34 presses the flap 34 open accordingly against the restoring force F of the restoring device 44, due to which the gas flow 24 can emerge from the outlet opening 30. As it emerges, the gas flow 24 is simultaneously deflected by the flap 34, in this example obliquely downwards in the direction of the underlying surface 37 (cf. FIG. 1).

In summary, it can be said that the emergency degassing element, which was previously referred to as the emergency degassing device 32, will be or is installed at the end 28a of the gas guide section, which is provided by the gas discharge channel 28, so that the harmful gas 24 can flow against it in as straight a line as possible. A flap 34 rotatably mounted on an axis 36 acts as an opening or triggering mechanism in the component, i.e. the emergency degassing device 32, which is pre-tensioned, for example, via a spring 44A and is thus pressed tightly against the carrier housing, namely the connector 38 or its contact flange 38a. In case of a thermal event and the resulting increase in pressure in the interior of the HV battery 14, the spring force F is overcome by the applied pressure on the flap surface of the flap 34 and the flap 34 opens. Depending on how great the gas pressure from the interior is, the flap 34 is opened to a greater or lesser extent. The possibility of directionally guiding the gas along the opening flap 34 in case of triggering is particularly advantageous in this concept. The harmful gas 24 is directed obliquely downwards, so that the gas flow 24 is only slightly deflected. In comparison to existing concepts, the gas 24 is redirected and swirled significantly less.

Overall, the examples show how the invention can provide an emergency degassing element for high-voltage batteries having a gas guiding function for the directed gas exhaust. The directed harmful gas exhaust can increase the safety of the vehicle occupant when leaving the vehicle in case of a thermal event. The gas can be directed deliberately to areas on the vehicle where the potential risk to the user is low.

1. An emergency degassing arrangement for a motor vehicle, comprising:
a gas discharge channel for discharging gases emerging from a battery cell from the motor vehicle into the surroundings of the motor vehicle,
an outlet opening of the gas discharge channel located at one end of the gas discharge channel and opening into the surroundings, and
an emergency degassing device which is arranged at the end of the gas discharge channel and has a closure which is designed to close the outlet opening and to release the outlet opening in order to discharge the gases into the surroundings,
wherein the closure has a flap which is rotatably mounted around a pivot axis for closing the outlet opening, wherein the flap is transferable from a closed position to at least one open position by rotating around the pivot axis, in which open position a gas flowing out of the outlet opening and partially flowing against the flap can be diverted by the flap.

2. The emergency degassing arrangement according to claim 1, wherein the emergency degassing device has a restoring device which is designed to exert a restoring force on the flap from the at least one open position in the direction of the closed position.

3. The emergency degassing arrangement according to claim 2, wherein the restoring device is designed such that the flap is held in the closed position by the restoring device in the absence of a counterforce counteracting the restoring force.

4. The emergency degassing arrangement according to claim 2, wherein the restoring device is designed such that an opening angle (a) of the flap in the open position is dependent on the strength of a gas flow flowing out of the outlet opening, wherein the opening angle (a) represents a pivot angle (a) by which the flap is pivoted from the closed position into the open position around the pivot axis.

5. The emergency degassing arrangement according to claim 1, wherein the pivot axis is arranged laterally to the outlet opening, preferably above the outlet opening and horizontally in relation to an intended installation position in a motor vehicle.

6. The emergency degassing arrangement according to claim 1, wherein the emergency degassing arrangement has a contact flange which is arranged circumferentially around the outlet opening, wherein the flap rests tightly on the contact flange in the closed position and thereby closes the outlet opening to form a seal, in particular wherein the flap has an inside facing toward the outlet opening, which has a sealing element which, in the closed position of the flap, rests circumferentially closed on the contact flange.

7. The emergency degassing arrangement according to claim 1, wherein the emergency degassing arrangement comprises a battery which has at least one battery cell which has a releasable cell degassing opening, wherein the emergency degassing arrangement is designed such that gas emerging from the releasable cell degassing opening is introducible into the gas discharge channel.

8. The emergency degassing arrangement according to claim 1, wherein the battery has a battery housing in which the at least one battery cell is arranged, wherein
the gas discharge channel extends at least partially outside the battery housing and the end of the gas discharge channel is arranged outside the battery housing, or
the outlet opening of the gas discharge channel is designed as an opening in the battery housing.

9. A motor vehicle having an emergency degassing arrangement according to claim 1.

10. A method for discharging gases emerging from a battery cell from a motor vehicle into the surroundings of the motor vehicle via a gas discharge channel and an outlet opening of the gas discharge channel located at one end of the gas discharge channel and opening into the surroundings, wherein an emergency degassing device is arranged at the end of the gas discharge channel, which has a closure which closes the outlet opening closes when no gas emerges and exposes the outlet opening to discharge the gases into the surroundings,
wherein the closure has a flap which is rotatably mounted around a pivot axis for closing the outlet opening, and the flap is transferred when gas emerges from a closed position to at least one open position by rotating around the pivot axis, in which open position the gas flowing out of the outlet opening and partially flowing against the flap is diverted by the flap.

11. The emergency degassing arrangement according to claim 3, wherein the restoring device is designed such that an opening angle (α) of the flap in the open position is dependent on the strength of a gas flow flowing out of the outlet opening, wherein the opening angle (α) represents a pivot angle (α) by which the flap is pivoted from the closed position into the open position around the pivot axis.

12. The emergency degassing arrangement according to claim 2, wherein the pivot axis is arranged laterally to the outlet opening, preferably above the outlet opening and horizontally in relation to an intended installation position in a motor vehicle.

13. The emergency degassing arrangement according to claim 3, wherein the pivot axis is arranged laterally to the outlet opening, preferably above the outlet opening and horizontally in relation to an intended installation position in a motor vehicle.

14. The emergency degassing arrangement according to claim 4, wherein the pivot axis is arranged laterally to the outlet opening, preferably above the outlet opening and horizontally in relation to an intended installation position in a motor vehicle.

15. The emergency degassing arrangement according to claim 2, wherein the emergency degassing arrangement has a contact flange which is arranged circumferentially around the outlet opening, wherein the flap rests tightly on the contact flange in the closed position and thereby closes the outlet opening to form a seal, in particular wherein the flap has an inside facing toward the outlet opening, which has a sealing element which, in the closed position of the flap, rests circumferentially closed on the contact flange.

16. The emergency degassing arrangement according to claim 3, wherein the emergency degassing arrangement has a contact flange which is arranged circumferentially around the outlet opening, wherein the flap rests tightly on the contact flange in the closed position and thereby closes the outlet opening to form a seal, in particular wherein the flap has an inside facing toward the outlet opening, which has a sealing element which, in the closed position of the flap, rests circumferentially closed on the contact flange.

17. The emergency degassing arrangement according to claim 4, wherein the emergency degassing arrangement has a contact flange which is arranged circumferentially around the outlet opening, wherein the flap rests tightly on the contact flange in the closed position and thereby closes the outlet opening to form a seal, in particular wherein the flap has an inside facing toward the outlet opening, which has a sealing element which, in the closed position of the flap, rests circumferentially closed on the contact flange.

18. The emergency degassing arrangement according to claim 5, wherein the emergency degassing arrangement has a contact flange which is arranged circumferentially around the outlet opening, wherein the flap rests tightly on the contact flange in the closed position and thereby closes the outlet opening to form a seal, in particular wherein the flap has an inside facing toward the outlet opening, which has a sealing element which, in the closed position of the flap, rests circumferentially closed on the contact flange.

19. The emergency degassing arrangement according to claim 3, wherein the emergency degassing arrangement comprises a battery which has at least one battery cell which has a releasable cell degassing opening, wherein the emergency degassing arrangement is designed such that gas emerging from the releasable cell degassing opening is introducible into the gas discharge channel.

20. The emergency degassing arrangement according to claim 3, wherein the emergency degassing arrangement comprises a battery which has at least one battery cell which has a releasable cell degassing opening, wherein the emergency degassing arrangement is designed such that gas emerging from the releasable cell degassing opening is introducible into the gas discharge channel.
